(19) United States
(12) Patent Application Publication
(10) Pub. No.: US 2025/0330254 A1
(43) Pub. Date: Oct. 23, 2025

(54) METHOD FOR WIRELESS COMMUNICATION AND USER EQUIPMENT

(71) Applicant: MEDIATEK INC., Hsinchu City (TW)

(72) Inventors: Tsung-Ming LEE, Hsinchu City (TW); Shang-An TSAI, Hsinchu City (TW); Jia-Hao WU, Hsinchu City (TW)

(21) Appl. No.: 19/093,561

(22) Filed: Mar. 28, 2025

Related U.S. Application Data
(60) Provisional application No. 63/635,665, filed on Apr. 18, 2024.

(51) Int. Cl. H04B 17/318; H04W 24/10; H04W 36/00; H04W 76/38

(52) U.S. Cl. CPC H04B 17/328; H04W 24/10; H04W 36/0055; H04W 76/38

(57) ABSTRACT

A method is provided. The method includes receiving a measurement configuration from a base station. The measurement configuration doesn't indicate that the UE can use a T312 timer. The method further includes determining an out-of-sync condition is present. The out-of-sync condition is that the SNR measured at the UE is lower than the SNR threshold. The method further includes determining whether a first condition and a second condition are present, in response to the out-of-sync condition being present. The first condition is that the RSRP measured at the UE is lower than the RSRP threshold, and the second condition is that the UE has already transmitted a measurement report to the base station. In response to the first condition and the second condition being present, the method further includes starting a customized timer having a duration shorter than that of a T310 timer.

### CROSS REFERENCE TO RELATED APPLICATIONS

This application claims priority of U.S. Provisional Application Ser. No. 63/635,665, filed on 2024 Apr. 18, the entirety of which are incorporated by reference herein.

### BACKGROUND OF THE INVENTION

### Field of the Invention

The present invention relates to wireless communication, and, in particular, to the declaration of radio link failure (RLF).

### Description of the Related Art

There are many situations where the user equipment (UE) will declare a radio link failure (RLF). One of these situations is when the T310 timer or the T312 timer expires. The T312 timer has a shorter duration than the T310 timer. The T312 timer is introduced to judge RLF earlier and to allow the UE to recover fast in a weak signal environment. However, the UE can use the T312 timer only when the T312 timer has been configured from the base station. When the UE hasn't been configured with the T312 timer, the UE can only use the T310 timer to judge the RLF.

Thus, how to shorten the process of detecting the RLF when the UE hasn't been configured with the T312 timer is a problem to be solved in the field.

BRIEF SUMMARY OF THE INVENTION

An embodiment of the present invention provides a method for wireless communication. The method comprises the operation of receiving a measurement configuration from a base station via user equipment (UE). The measurement configuration doesn't indicate that the UE can use a T312 timer. The method further comprises the operation of determining an out-of-sync condition is present. The out-of-sync condition is that the signal-to-noise ratio (SNR) measured at the UE is lower than the SNR threshold. The method further comprises the following operation: in response to a determination that an out-of-sync condition is present, the UE determines whether a first condition and a second condition are present. The first condition is that the reference signal receiving power (RSRP) measured at the UE is lower than the RSRP threshold, and the second condition is that the

UE has already transmitted a measurement report to the base station. The method further comprises the following operation: in response to a determination that the first condition and the second condition are present, the UE starts a customized timer that has a duration shorter than that of a T310 timer.

An embodiment of the present invention provides A UE comprising a transceiver and a control circuit. The transceiver is configured to receive a measurement configuration from a base station. The measurement configuration doesn't indicate that the UE can use a T312 timer. The control circuit is configured to determine an out-of-sync condition is present. The out-of-sync condition is that the SNR measured at the UE is lower than the SNR threshold. In response to a determination that an out-of-sync condition is present, the control circuit is further configured to determine whether a first condition and a second condition are present. The first condition is that the RSRP measured at the UE is lower than the RSRP threshold, and the second condition is that the UE has already transmitted a measurement report to the base station. The control circuit is further configured to start a customized timer that has a duration shorter than that of a T310 timer, in response to a determination that the first condition and the second condition are present.

### BRIEF DESCRIPTION OF THE DRAWINGS

The present invention can be more fully understood by reading the subsequent detailed description and examples with references made to the accompanying drawings, wherein:

FIG. 1 is a block diagram of the user equipment in accordance with embodiments of the present disclosure;

FIG. 2 is a schematic diagram in accordance with embodiments of the present disclosure;

FIG. 3 is a flow diagram of a method in accordance with embodiments of the present disclosure; and

FIG. 4 is a flow diagram of a method in accordance with embodiments of the present disclosure.

### DETAILED DESCRIPTION OF THE INVENTION

The following description is made for the purpose of illustrating the general

principles of the invention and should not be taken in a limiting sense. The scope of the invention is best determined by reference to the appended claims.

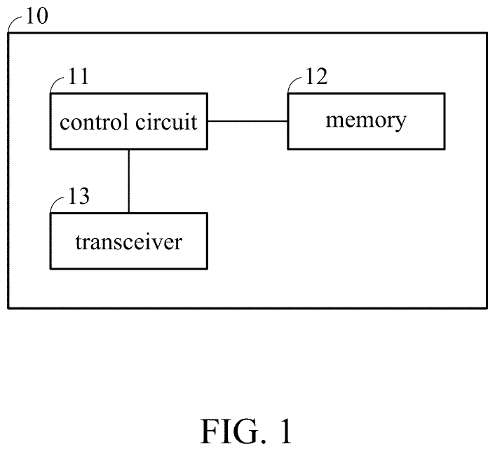

FIG. 1 is a block diagram of the user equipment (UE) 10 in accordance with embodiments of the present disclosure. UE 10 may perform various functions to implement processes and methods described herein. For example, UE 10 may be a mobile apparatus, a wearable apparatus, a wireless communication apparatus, or a computing apparatus. In some embodiments, UE 10 is implemented in a smartphone, a wearable device, an Internet of Things (IoT) device, a tablet computer, or a notebook computer. UE 10 may be implemented in the form of one or more integrated-circuit (IC) chips. In some embodiments, UE 10 connects to a base station. The base station may be an access point, an access terminal, a network node, an evolved Node-B (eNB), or a gNodeB (gNB). The UE 110 may connect to a network (such as Internet) through the base station. In some embodiments, UE 10 comprises a control circuit 11, a memory 12, and a transceiver 13.

The control circuit 11 controls operations of the UE 10. The control circuit 11 provides the required process ability to perform operating systems, programs, software, modules, applications, and functions of the UE 10. In some embodiments, the control circuit 11 may be implemented in the form of hardware with electronic components including transistors, diodes, capacitors, resistors, or inductors. These components are configured and arranged to achieve specific purposes in accordance with the embodiments of the present disclosure. In other words, the control circuit 11 is a special-purpose machine specifically configured to perform specific tasks including method in accordance with the embodiments of the present disclosure. For example, the control circuit 11 may be a general-purpose micro-processor, a central processing unit (CPU), a controller, a micro control unit, and/or related chip set.

The memory 12 stores data required by the control circuit 11. The memory 12 may include non-volatile memories, such as read only memory (ROM) and flash memory. The memory 12 may also include volatile memories, such as dynamic random access memory (DRAM) and static random access memory (SRAM). In some embodiments, the memory 12 stores a program (e.g. computer-readable instruction). The program can be operated by the control circuit 11. When the program is operated by the control circuit 11, the program causes the control circuit 11 to implement methods according to the embodiments of the present disclosure.

The transceiver 13 is capable to transmit and receive data wirelessly. The transceiver 13 is coupled with one or more antennas (not shown). The transceiver 13 receives radio frequency (RF) signals from the antenna and converts RF signals to baseband signals. The transceiver 13 also converts the baseband signals to the RF signals and sends out the RF signals through the antenna.

Moreover, the UE 10 may comprise other components, which are not shown in FIG. 1. In some embodiments, the UE 10 further comprises a SNR/RSRP measurement circuit for measuring the SNR/RSRP, a display or a touch screen, an internal power supply, an antenna or an antenna array connected to the transceiver 13.

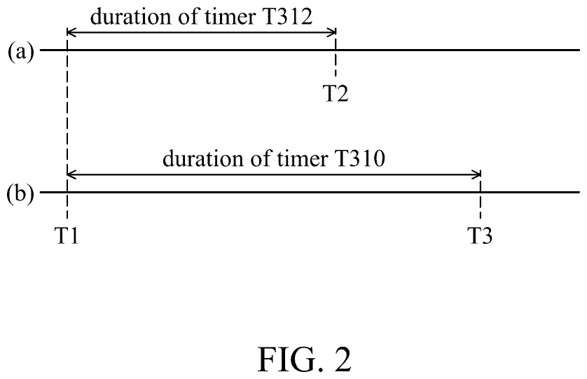

FIG. 2 is a schematic diagram in accordance with embodiments of the present disclosure. The (a) part of FIG. 2 shows the situation that the UE 10 is configured with the T312 timer, and the (b) part of FIG. 2 shows the situation that the UE 10 isn't configured with the T312 timer. At time point T1, UE 10 determines that a predefined number of consecutive out-of-sync conditions are present. The out-of-sync condition is that the signal-to-noise ratio (SNR) measured at the UE 10 is lower than the SNR threshold. The predefined number is an integer greater than zero. In (a) part of FIG. 2, in response to a determination that the predefined number of consecutive out-of-sync conditions are present, the UE 10 starts the T312 timer at time point T1. In (b) part of FIG. 2, in response to a determination that the predefined number of consecutive out-of-sync conditions are present, the UE 10 starts the T310 timer at time point T1. At time point T2, timer T312 expires. After timer T312 expires, the UE 10 determines that an RLF is present. At time point T3 which is after time point T2, timer T310 expires. After timer T310 expires, the UE 10 determines that an RLF is present.

Because the duration of the timer T312 is shorter than the duration of the timer T310, using the timer T312 can detect the RLF earlier. Detecting RLF earlier means that the UE can perform reestablishment process earlier so as to recover from the problem caused by the weak signal environment. However, the UE is only configured with the T310 timer by default. The UE can use the T312 timer only when the T312 timer has been configured from the base station, and the base station seldom configures the T312 timer. When the UE isn't configured with the T312 timer, the UE can only use the T310 timer to judge the present of the RLF. Embodiments in accordance with the present disclosure allow the UE to detect RLF earlier without the use of the T312 timer.

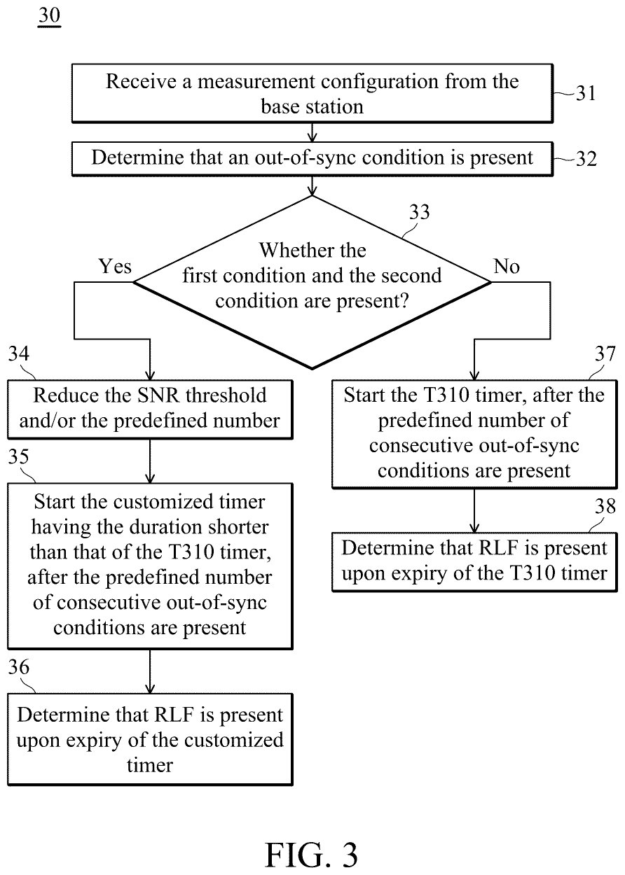

FIG. 3 is a flow diagram of a method 30 in accordance with embodiments of the present disclosure. The method 30 can be performed by the UE 10. In operation 31, the UE 10 receives a measurement configuration from the base station via the transceiver 13. The measurement configuration doesn't indicate that the UE can use a T312 timer. In other words, the measurement configuration doesn't comprise a configuration of the T312 timer. The base station doesn't configure the T312 timer for the UE 10 in the measurement configuration, and the UE 10 isn't allowed to (can't) use the T312 timer. In some embodiments, the measurement configuration may comprise frequency/time location of the measurement, the reference signal (RS) type used for measurements, the reporting format, and/or the trigger condition of the measurements.

In operation 32, the control circuit 11 determines an out-of-sync condition is present (i.e. satisfied). The out-of-sync condition is that the SNR measured at the UE 10 is lower than the SNR threshold. The UE 10 measures the SNR and determines that the measured SNR is lower than the SNR threshold, so as to determine that an out-of-sync condition is present (i.e. satisfied). In response to a determination that an out-of-sync condition is present, the control circuit 11 determines whether the first condition and the second condition are present (i.e. satisfied), in operation 33. The first condition is that the reference signal receiving power (RSRP) measured at the UE 10 is lower than the RSRP threshold. The UE 10 measures the RSRP and determines that the measured RSRP is lower than the RSRP threshold, so as to determine that the first condition is present. For a non-limiting example, the RSRP threshold is −125 dBm. The second condition is that the UE 10 has already transmitted a measurement report to the base station. In some embodiments, the measurement report comprises the RSRP measured at the UE 10. In some embodiments, the measurement report is transmitted in response to an A2 event. The A2 event may be the signal quality (e.g. RSRP or Reference Signal Received Quality (RSRQ)) of the serving cell falls below a threshold. The measurement report may indicate that A2 event happened. In response to a determination that the first condition and the second condition are present (i.e. the measured RSRP is lower than the RSRP threshold and the UE 10 has already transmitted the measurement report, which may comprise the measured RSRP, to the base station), the UE 10 performs operation 34. In response to a determination that the first condition or the second condition isn't present (i.e. any one of the first condition or the second condition isn't present, or both the first condition and the second condition aren't present), the UE 10 performs operation 37.

In operation 34, the control circuit 11 reduces the SNR threshold and/or the predefined number. In operation 35, the control circuit 11 starts the customized timer having a duration shorter than that of the T310 timer, after the predefined number of consecutive out-of-sync conditions are present. For example, in operation 34, the UE 10 may reduce the SNR threshold from the first value to the second value and reduce the predefined number from the third value to the fourth value. In operation 35, when the measured SNR is lower than the reduced SNR threshold (the second value), the control circuit 11 determines that an out-of-sync condition presents. Furthermore, after the reduced predefined number (the fourth value) of consecutive out-of-sync conditions are present, the control circuit 11 starts the customized timer having a duration shorter than that of the T310 timer. In some embodiments, after operation 34, the UE 10 may periodically measure the SNR and thus determine that the predefined number of consecutive out-of-sync conditions are present.

In operation 36, the control circuit 11 determines that RLF is present upon expiry of the customized timer (the timer having a duration shorter than that of the T310 timer). In response to a determination that an RLF is present, the control circuit 11 controls the transceiver 13 to transmit the reestablishment request to the base station. The reestablishment request indicates that the UE 10 requests to reestablish the link with the base station. After transmitting the reestablishment request, the UE 10 may receive a reestablishment configuration from the base station. Then, the UE 10 may reestablish the link to the base station based on the reestablishment configuration.

In operation 37, the control circuit 11 starts the T310 timer, after the predefined number of consecutive out-of-sync conditions are present. In response to a determination that the first condition or the second condition isn't present, the control circuit 11 doesn't reduce the SNR threshold and the predefined number. For example, control circuit 11 doesn't reduce the SNR threshold from the first value to the second value and doesn't reduce the predefined number from the third value to the fourth value. Thus, in operation 37, when the measured SNR is lower than the original SNR threshold (the first value), the UE 10 determines that an out-of-sync condition is present. Furthermore, after the original predefined number (the third value) of consecutive out-of-sync conditions are present, the UE 10 starts the T310 timer. In some embodiments, after operation 33, the UE 10 may periodically measure the SNR and thus determine that the predefined number of consecutive out-of-sync conditions are present. In operation 38, the UE 10 determines that an RLF is present upon expiry of the T310 timer.

In response to a determination that an RLF is present, the control circuit 11 controls the transceiver 13 to transmit the reestablishment request to the base station. The reestablishment request indicates that the UE 10 requests to reestablish the link with the base station. After transmitting the reestablishment request, the UE 10 may receive a reestablishment configuration from the base station. Then, the UE 10 may reestablish the link to the base station based on the reestablishment configuration.

Embodiments of the present disclosure can detect the RLF earlier when the UE isn't configured with the T312 timer via reducing the SNR threshold, reducing the predefined number, and using the customized timer. Thus, embodiments of the present disclosure allow the UE to reestablish the link earlier. It is noted that embodiments of the present disclosure only accelerate the RLF detection process under certain conditions. Because reestablishing the link costs the UE a large amount of resource, reestablishing the link too frequently isn't preferable. Furthermore, in some embodiments, while the T310 timer or the customized timer is running, the UE 10 may determine that an in-sync condition is present and thus stops the T310 timer or the customized timer. The T310 timer or the customized timer being stopped means that the UE 10 won't determine that RLF is present and won't perform reestablishment. Thus, accelerating the RLF detection process when both the first condition and the second condition are present can avoid the UE to reestablish the link too frequently. When the RSRP is low, there's a high chance that RLF will happen. Furthermore, after the UE has transmitted the measurement report indicating the low RSRP, in general, the base station will release the UE or handover the UE. If the base station doesn't release the UE or handover the UE, it is beneficial to request to reestablish the link by the UE as soon as possible. Thus, embodiments of the present disclosure can accelerate the RLF detection process at the proper timing.

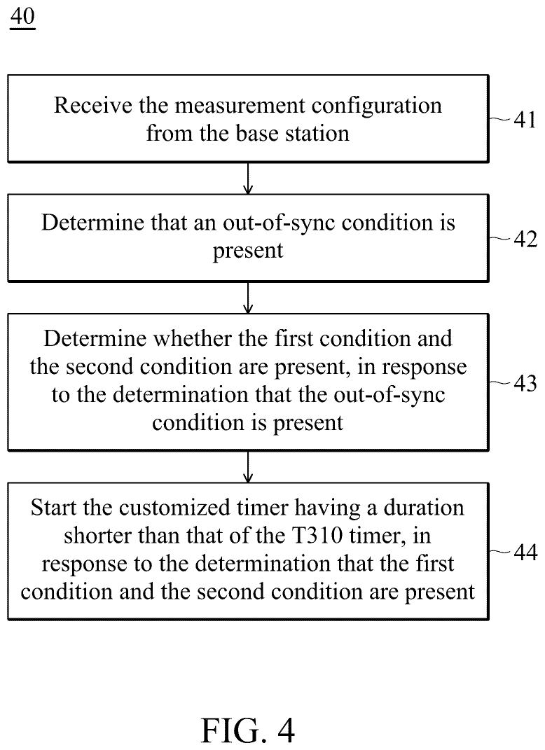

FIG. 4 is a flow diagram of a method 40 in accordance with embodiments of the present disclosure. The method 40 can be performed by the UE 10. In operation 41, the UE 10 receives the measurement configuration from the base station via the transceiver 13. The measurement configuration doesn't comprise a configuration of a T312 timer. In operation 42, the control circuit 11 determines an out-of-sync condition is present. The out-of-sync condition is that the SNR measured at the UE is lower than the SNR threshold (the original value). In operation 43, in response to a determination that an out-of-sync condition is present, the control circuit 11 determines whether the first condition and the second condition are present. The first condition is that the RSRP measured at the UE 10 is lower than the RSRP threshold. The second condition is that the UE 10 has already transmitted a measurement report to the base station. In operation 44, in response to a determination that the first condition and the second condition are present, the control circuit 11 starts the customized timer having a duration shorter than that of a T310 timer.

In some embodiments, the control circuit 11 is configured to reduce the SNR threshold, in response to a determination that the first condition and the second condition are present. In some embodiments, the control circuit 11 is configured to start the customized timer having a duration shorter than that of the T310 timer, after a predefined number of consecutive out-of-sync conditions are present, in response to a determination that the first condition and the second condition are present. In some embodiments, the control circuit 11 is configured to reduce the predefined number, in response to a determination that the first condition and the second condition are present.

In some embodiments, the measurement report comprises the RSRP measured at the UE 10. In some embodiments, the control circuit 11 is configured to determine the RLF is present upon expiry of the customized timer. The control circuit 11 is configured to control the transceiver 13 to transmit a reestablishment request to the base station in response to a determination that an RLF is present. The reestablishment request indicates that the UE 10 requests to reestablish the link with the base station.

In some embodiments, the control circuit 11 is configured to start the T310 timer after a predefined number of consecutive out-of-sync conditions are present, in response to a determination that the first condition or the second condition isn't present. The control circuit 11 is configured to determine RLF is present upon expiry of the T310 timer. The control circuit 11 is configured to control the transceiver 13 to transmit a reestablishment request to the base station, in response to a determination that an RLF is present. The reestablishment request indicates that the UE 10 requests to reestablish the link with the base station.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for wireless communication, comprising:
receiving a measurement configuration from a base station via a user equipment (UE), wherein the measurement configuration doesn't indicate that the UE can use a T312 timer;
determining, via the UE, that an out-of-sync condition is present, wherein the out-of-sync condition is that a signal-to-noise ratio (SNR) measured at the UE is lower than an SNR threshold;
in response to a determination that the out-of-sync condition is present, determining, via the UE, whether a first condition and a second condition are present, wherein the first condition is that a reference signal receiving power (RSRP) measured at the UE is lower than an RSRP threshold, wherein the second condition is that the UE has already transmitted a measurement report to the base station; and
in response to a determination that the first condition and the second condition are present, starting a customized timer having a duration shorter than that of a T310 timer via the UE.

2. The method as claimed in claim 1, further comprising:
in response to the determination that the first condition and the second condition are present, reducing, via the UE, the SNR threshold.

3. The method as claimed in claim 1, further comprising:
in response to the determination that the first condition and the second condition are present, starting, via the UE, the customized timer having the duration shorter than that of the T310 timer, after a predefined number of consecutive the out-of-sync conditions are present.

4. The method as claimed in claim 3, further comprising:
in response to the determination that the first condition and the second condition are present, reducing, via the UE, the predefined number.

5. The method as claimed in claim 1, wherein the measurement report comprises the RSRP measured at the UE.

6. The method as claimed in claim 1, further comprising:
determining, via the UE, that a radio link failure (RLF) is present upon expiry of the customized timer; and
in response to the determination that the RLF is present, transmitting, via the UE, a reestablishment request to the base station, wherein the reestablishment request indicates that the UE requests to reestablish the link with the base station.

7. The method as claimed in claim 1, further comprising:
in response to a determination that the first condition or the second condition isn't present, starting, via the UE, the T310 timer after a predefined number of consecutive the out-of-sync conditions are present;
determining, via the UE, that a radio link failure (RLF) is present upon expiry of the T310 timer; and
in response to the determination that the RLF is present, transmitting a reestablishment request to the base station via the UE, wherein the reestablishment request indicates that the UE requests to reestablish the link with the base station.

8. A user equipment (UE), comprising:
a transceiver, configured to receive a measurement configuration from a base station, wherein the measurement configuration doesn't indicate that the UE can use a T312 timer; and
a control circuit, configured to:
determine that an out-of-sync condition is present, wherein the out-of-sync condition is that a signal-to-noise ratio (SNR) measured at the UE is lower than an SNR threshold;
in response to a determination that the out-of-sync condition is present, determine whether a first condition and a second condition are present, wherein the first condition is that a reference signal receiving power (RSRP) measured at the UE is lower than an RSRP threshold, wherein the second condition is that the UE has already transmitted a measurement report to the base station;
in response to a determination that the first condition and the second condition are present, start a customized timer having a duration shorter than that of a T310 timer.

9. The UE as claimed in claim 8, wherein in response to the determination that the first condition and the second condition are present, the control circuit is further configured to reduce the SNR threshold.

10. The UE as claimed in claim 8, wherein in response to the determination that the first condition and the second condition are present, the control circuit is further configured to start the customized timer having the duration shorter than that of the T310 timer, after a predefined number of consecutive the out-of-sync conditions are present.

11. The UE as claimed in claim 10, wherein in response to the determination that the first condition and the second condition are present, the control circuit is further configured to reduce the predefined number.

12. The UE as claimed in claim 8, wherein the measurement report comprises the RSRP measured at the UE.

13. The UE as claimed in claim 8, wherein the control circuit is further configured to:
determine that a radio link failure (RLF) is present upon expiry of the customized timer; and
in response to a determination that the RLF is present, control the transceiver to transmit a reestablishment request to the base station, wherein the reestablishment request indicates that the UE requests to reestablish the link with the base station.

14. The UE as claimed in claim 8, wherein the control circuit is further configured to:
in response to a determination that the first condition or the second condition isn't present, start the T310 timer after a predefined number of consecutive the out-of-sync conditions are present;
determine that a radio link failure (RLF) is present upon expiry of the T310 timer; and
in response to a determination that the RLF is present, control the transceiver to transmit a reestablishment request to the base station, wherein the reestablishment request indicates that the UE requests to reestablish the link with the base station.
